(19) United States
(12) Patent Application Publication
(10) Pub. No.: US 2024/0202051 A1
(43) Pub. Date: Jun. 20, 2024

(54) ROUTING FOR DATA GRID IN A COMPUTING CLUSTER

(71) Applicant: Red Hat, Inc., Raleigh, NC (US)

(72) Inventors: Vittorio Rigamonti, Pregnana Milanese (IT); Paolo Antinori, Novara (IT)

(21) Appl. No.: 18/085,069

(22) Filed: Dec. 20, 2022

(51) Int. Cl. G06F 9/54; G06F 8/60

(52) U.S. Cl. CPC G06F 9/542; G06F 8/60

(57) ABSTRACT

A method includes receiving a description of a data grid topology of a containerized computing cluster, wherein the containerized computing cluster comprises a plurality of nodes that are divided into a plurality of partitions and each partition of the plurality of partitions is identified by a respective partition number, and the data grid topology maps the respective partition number to an address of corresponding nodes for the respective partition; labeling each pod with a partition number according to the data gird topology, wherein each pod comprises one or more virtualized computing entities running on one or more host computer systems, wherein each pod corresponds to a node of the plurality of nodes; creating a routing service for each partition number, wherein the routing service comprises an application programmer interface (API) object identifying at least one pod; and creating a routing API object to route a request to the routing service.

### TECHNICAL FIELD

The present disclosure is generally related to cluster computing environment, and more particularly, to routing for data grid in a computing cluster.

### BACKGROUND

Cluster computing environments can provide computing resources, such as host computer systems, networks, and storage devices that can perform data processing tasks and can be scaled to handle larger tasks by adding or upgrading resources. Virtualization techniques can be used to create multiple “virtual machines” on each physical host computer system, so the host computer systems can be used more efficiently and with greater flexibility. A hypervisor may run on each host computer system and manage multiple virtual machines. Such virtualization techniques thus provide abstractions of the physical components into logical objects in order to allow running various software modules, for example, multiple operating systems, concurrently and in isolation from other software modules, on one or more interconnected physical computer systems.

Data, such as software programs, information, or other forms of data, has become a resource and asset for many individuals and businesses. A data grid is a distributed database system with increased computing power and storage capacity that can store and manage data across a collection of nodes. Data grids can provide functionalities such as storing, searching, and processing data.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example of a computer system architecture, in accordance with one or more aspects of the present disclosure.

FIG. 2 depicts a component diagram of an example of a containerized computing cluster, in accordance with one or more aspects of the present disclosure.

FIGS. 3A-3C depict examples of configuring a routing system, in accordance with one or more aspects of the present disclosure.

FIG. 3D depicts an example of routing a request using the routing system configured in FIGS. 3A-3C, in accordance with one or more aspects of the present disclosure.

FIGS. 4, 5, and 6 depict flow diagrams of example methods for implementing a routing system for data grid in a containerized computing cluster, in accordance with one or more aspects of the present disclosure.

FIG. 7 depicts a block diagram of an example computer system operating in accordance with one or more aspects of the present disclosure.

### DETAILED DESCRIPTION

Described herein are methods and systems for implementing a routing system for data grid in a computing cluster. A computing cluster may be a group of physical or virtual host machines that run containerized applications. The computing cluster may include virtualized computing entities that represent resources in the cluster, such as virtual machines, nodes, storage volumes, and networks. An application may run in association with a cluster entity, which may handle infrastructure-related tasks such as deployment of the application for operation.

Data can be distributed across multiple entities in a cluster. Data grids, as distributed database systems, can manage distributed data, where the data can be stored across multiple locations and multiple types of storage devices. The data grid can be a collection of nodes, where the nodes can be physical machines, virtual machines, computers, servers, collections of physical machines or virtual machines, and so forth. The nodes can include memories, such as a cache, for storing data. Data grids can pool together memories to allow applications to store and retrieve data and to allow applications to share data with other applications executing on the cluster. Data grids are typically designed for large-scale applications that need more memories than is typically available in a single server. Such data grids are designed for data processing with high speed and low latency.

Data grids can be designed using key-value data stores that share entries across different nodes. Multiple nodes are divided into partitions and each partition corresponds to a respective partition number. For example, N nodes can be divided into M partitions, the first N/M nodes can be assigned to partition number 1, the second N/M nodes can be assigned to partition number 2, . . . , and the last N/M nodes can be assigned to partition number M. An entry can refer to data representing a value of a key-value pair and can be stored on a partition of the nodes, where the partition can be referenced by a partition number. A node that stores an entry or that is requested to store an entry is referred to as an “owner” node of that entry. Entries are often distributed on the data grid cluster using a consistent hashing technique. A consistent hashing technique can use a hashing function (i.e., a function that maps a key (i.e., a key of an entry) to a hash value used to index a hash table that holds data) and in addition to the standard hashing function, allow a resize of the hash table without the need of remapping all keys. Thus, the consistent hashing can be used, in combination with the cluster configuration of the data grid, to assign a node for storage of an entry. The cluster configuration of the distributed data grid, referred to as the “data grid topology,” includes topology information of a set of nodes, for example, a mapping of a partition number identifying a partition of the nodes to the network addresses of the nodes comprised by the partition.

For example, if a set of entries (e.g., web pages, video segments, or any other type of data) is to be assigned to a set of n nodes in a cluster. The set of entries may be distributed evenly across the n nodes using a hash function to store entry o in a node. However, if a node is added or removed from the cluster (resulting in the changing of value n), the node assignment of nearly every entry in the data grid may change. In a cluster where nodes are continually instantiated, this may require a large proportion of data objects to be moved to different nodes. Consistent hashing may be used to avoid node reassignment for entries when a node is added or removed from the data grid. In the consistent hashing, a hash function (referred to as “consistent hash function”) is used to map entries to nodes in a unit circle (i.e., a circle where entries and nodes are placed), where the entry and the node correspond to each other in the unit circle with respect to an axis. Specifically, each entry o is assigned to the next node that appears on the circle (e.g., in clockwise order). This provides an even distribution of entries to nodes. If a node is unable to accommodate a particular entry (e.g., where a node has insufficient memory), the entry may be allocated to the next node on the circle. Additionally, if a node fails (and is thus removed from the unit circle), only the entries that are owned by that node are reassigned to the next node (e.g., in clockwise order or counterclockwise order, depending on the consistent hashing algorithm). Similarly, if a new node is instantiated, the node may be added to the unit circle and only entries owned by that node are reassigned. Importantly, when a node is added or removed, the vast majority of entries maintain their previous node affiliation. As such, the data grid topology may be used with the consistent hashing algorithm to consistently determine on which node an entry will be stored.

An application can issue a request (e.g., to retrieve and/or store data) to any node of a data grid cluster. However, if the request is sent to a non-owner node of the cluster, the request will need to be propagated to an owner node in order to be served. Such re-routing can adversely affect the cluster performance.

For example, clusters of containers managed using a container orchestration service such as Red Hat® OpenShift®, Kubernetes®, etc., are designed to be application-agnostic. These container orchestration services take control of instances of software and use their own request-routing logic. Often, such routing logic uses common services that are compatible with different applications. For a given application request, these services apply general policy to share the requested load and may employ round robin logic that randomly selects a node to which to route the request. This often results in the request being propagated from node to node until an owner node is found. Thus, while such common services may be beneficial in terms of reliability, due to simple routing logic, the routing logic may result in routing inefficiencies.

In some systems, to avoid such re-routing, the application can be equipped with logic enabling the application to identify the correct owner node and to thereby send the request directly to the owner node. In such a case, the application needs to know information related to consistent hashing and data grid topology. However, since consistent hashing requires connectivity to all nodes of the data grid, and thus, the application requesting the information related to the consistent hashing would need all nodes of the data grid to be exposed externally. This can lead to a waste of network resources and security issues, especially when the data grid has hundreds of nodes.

Aspects of the present disclosure address the above and other deficiencies by implementing a component running on a server to acquire, update and maintain data grid topology of a cluster and configure a routing system based on the up-to-date data grid topology. The routing system can serve as a proxy hub that can consistently maintain topology information utilized for request routing. Upon receiving a request from an application (e.g., via a client device), the component running on the server can instantly use the routing system that is consistent with up-to-date data grid topology to obtain the information about the route to the correct owner node. As such, the client does not need to know the data grid topology, and the client requires minimum calculation to generate a request and get a fast response.

Specifically, the nodes of the cluster can be divided into multiple partitions and each partition of nodes corresponds to a respective partition number, and the data grid topology maps the respective partition number to an address of the corresponding partition of nodes. To configure the routing system, a proxy component running on the server acquires the data grid topology data including the partition number and corresponding nodes information, for example, through a data grid application. The proxy component then uses the data grid topology data to build the routing system, for example, via using a container orchestration service. Specifically, the proxy component labels each Pod with the corresponding partition number, where Pod refers to a basic entity that includes one or more containers/virtual machines and runs on a node. The proxy component creates a Service for each partition number, wherein Service refers to an abstract way to define a logical set of Pods and a policy by which to access the set of Pods. The proxy component creates an Ingress, where Ingress refers to an API object that manages external access to Services. As such, the Ingress is used to route a request to a corresponding Service, and the Service is used to identify a corresponding Pod (and corresponding node). Therefore, the proxy component configures the routing system that can route a request to an owner node. The proxy component can consistently acquire, update, and maintain the data grid topology data and consistently maintain the routing system by updating Pod, Service, Ingress according to the data grid topology.

A client device can generate a request to read or write an entry in an owner node. The client device can generate the request by computing a partition number using a consistent hash function based on a key of the entry and adding the partition number in the request. As such, when the client device sends a request that includes the partition number to a proxy component running on the server, the proxy component can use the routing system that has been configured and maintained as described above to obtain a route to the correct owner node. Specifically, upon receiving the request with the partition number, the proxy component can use the ingress to route the request to the corresponding Service, and the Service can be used to identify (e.g., select) the corresponding Pod and the corresponding node, which is the owner node. The owner node can receive and process the request and send a response to the client device.

Advantages of the present disclosure include enhancing functionality by rendering a server in the cluster capability for acquiring and maintaining data grid topology and configuring a consistent routing system to route incoming requests to correct owner nodes. The present disclosure also improves efficiency and speed of routing incoming requests. In addition, using a dynamic routing system for data grid in a containerized computing cluster provides an efficient way to maintain, update, and manage data grid topology.

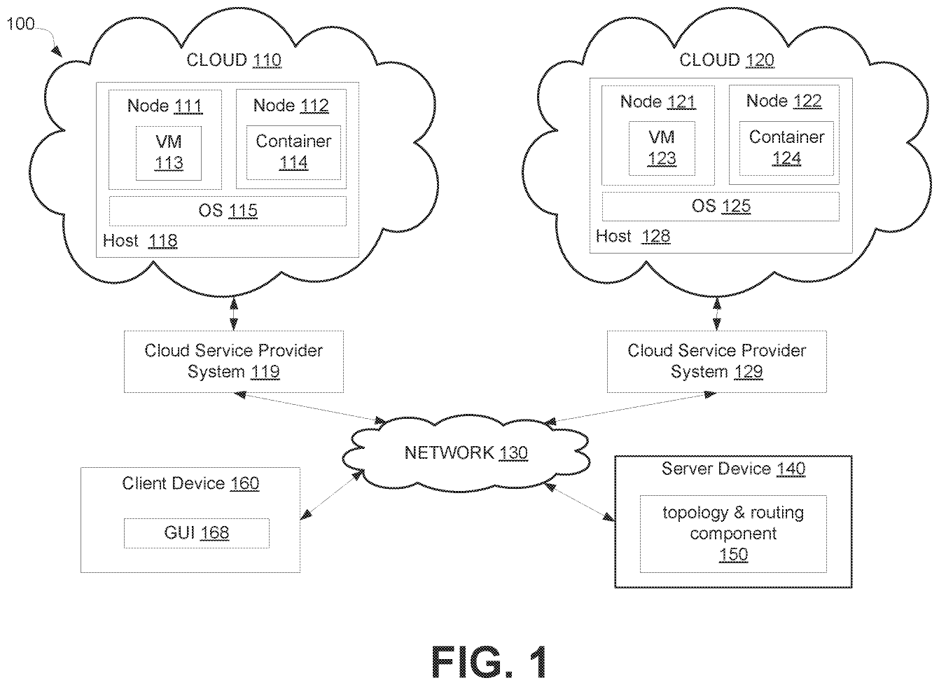

FIG. 1 is a block diagram of a network architecture 100 in which implementations of the disclosure may operate. In some implementations, the network architecture 100 may be used in a containerized computing services platform. A containerized computing services platform may include a Platform-as-a-Service (PaaS) system, such as Red Hat® OpenShift®. The PaaS system provides resources and services (e.g., micro-services) for the development and execution of applications owned or managed by multiple users. A PaaS system provides a platform and environment that allow users to build applications and services in a clustered compute environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes one or more cloud-computing environment 110, 120 (also referred to herein as a cloud(s)) that includes nodes 111, 112, 121, 122 to execute applications and/or processes associated with the applications. A “node” providing computing functionality may provide the execution environment for an application of the PaaS system. In some implementations, the “node” may include a virtual machine (VMs 113, 123) that is hosted on a physical machine, such as host 118, 128 implemented as part of the clouds 110, 120. For example, nodes 111 and 112 are hosted on physical machine of host 118 in cloud 110 provided by cloud provider 119. Similarly, nodes 121 and 122 are hosted on physical machine of host 128 in cloud 120 provided by cloud provider 129. In some implementations, nodes 111, 112, 121, and 122 may additionally or alternatively include a group of VMs, a container (e.g., container 114, 124), or a group of containers to execute functionality of the PaaS applications. When nodes 111, 112, 121, 122 are implemented as VMs, they may be executed by operating systems (OSs) 115, 125 on each host machine 118, 128. It should be noted, that while two cloud providers systems have been depicted in FIG. 1, in some implementations more or fewer cloud service provider systems (and corresponding clouds) may be present.

In some implementations, the host machines 118, 128 can be located in data centers. Users can interact with applications executing on the cloud-based nodes 111, 112, 121, 122 using client computer systems (not pictured), via corresponding client software (not pictured). Client software may include an application such as a web browser. In other implementations, the applications may be hosted directly on hosts 118, 128 without the use of VMs (e.g., a “bare metal” implementation), and in such an implementation, the hosts themselves are referred to as “nodes”.

In various implementations, developers, owners, and/or system administrators of the applications may maintain applications executing in clouds 110, 120 by providing software development services, system administration services, or other related types of configuration services for associated nodes in clouds 110, 120. This can be accomplished by accessing clouds 110, 120 using an application programmer interface (API) within the applicable cloud service provider system 119, 129. In some implementations, a developer, owner, or system administrator may access the cloud service provider system 119, 129 from a client device (e.g., client device 160) that includes dedicated software to interact with various cloud components. Additionally, or alternatively, the cloud service provider system 119, 129 may be accessed using a web-based or cloud-based application that executes on a separate computing device (e.g., server device 140) that communicates with client device 160 via a network 130.

Client device 160 is connected to host 118 in cloud 110 and host 128 in cloud 120 and the cloud service provider systems 119, 129 via a network 130, which may be a private network (e.g., a local area network (LAN), a wide area network (WAN), intranet, or other similar private networks) or a public network (e.g., the Internet). Each client 160 may be a mobile device, a PDA, a laptop, a desktop computer, a tablet computing device, a server device, or any other computing device. Each host 118, 128 may be a server computer system, a desktop computer, or any other computing device. The cloud service provider systems 119, 129 may include one or more machines such as server computers, desktop computers, etc. Similarly, server device 140 may include one or more machines such as server computers, desktop computers, etc.

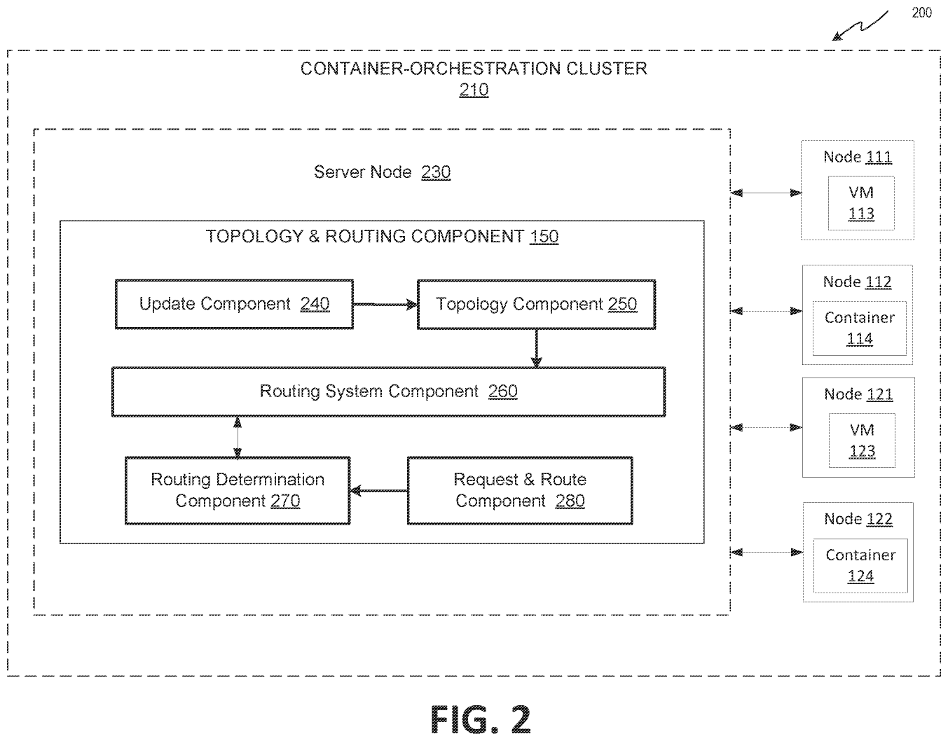

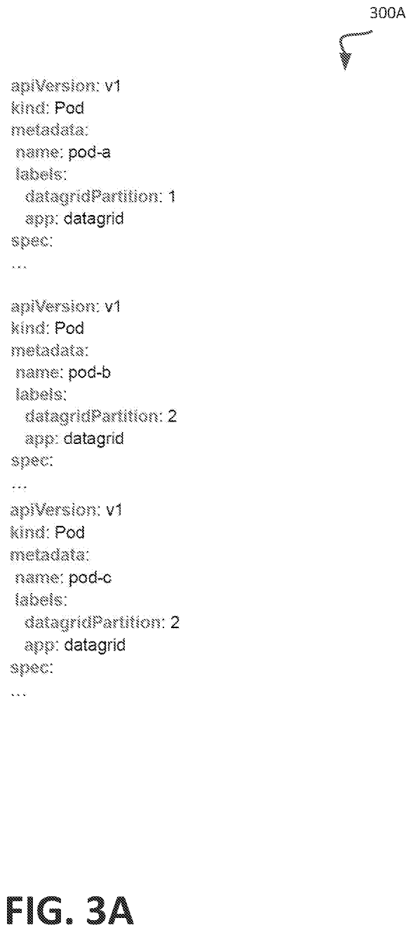

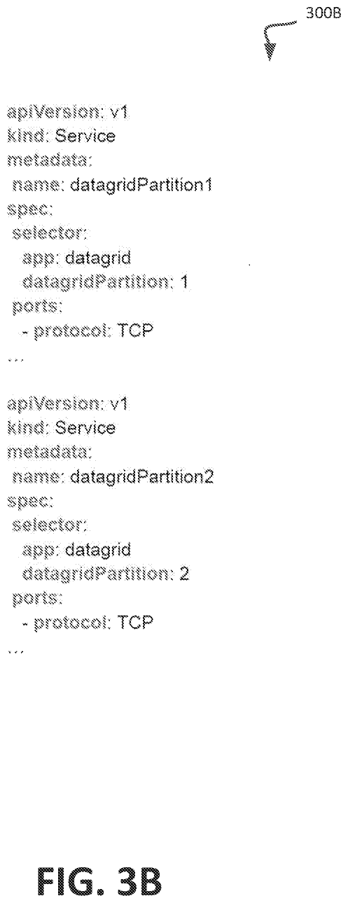

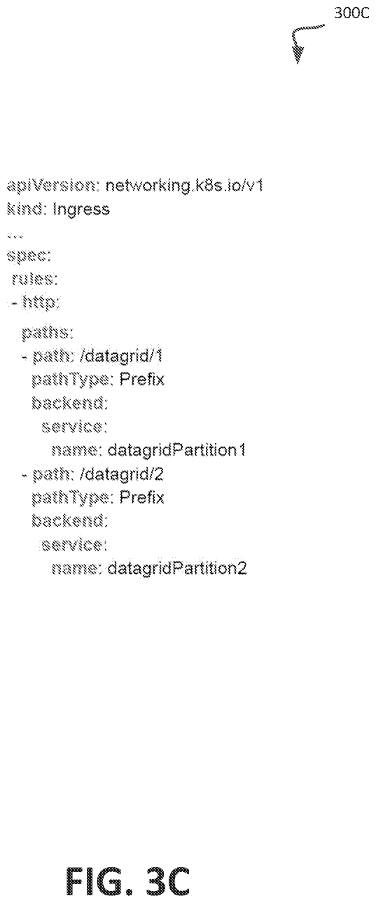

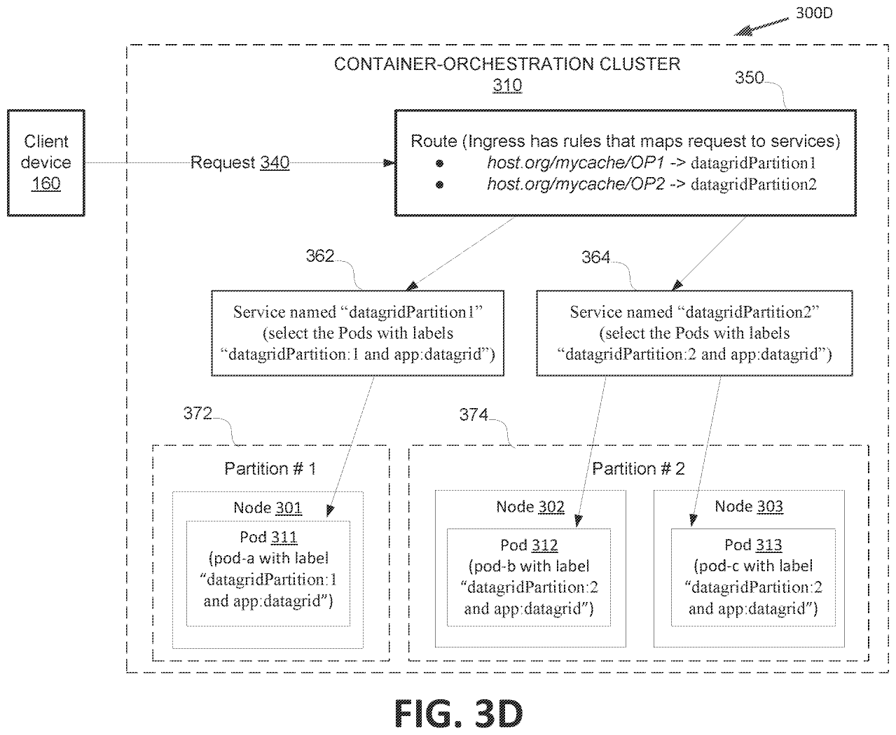

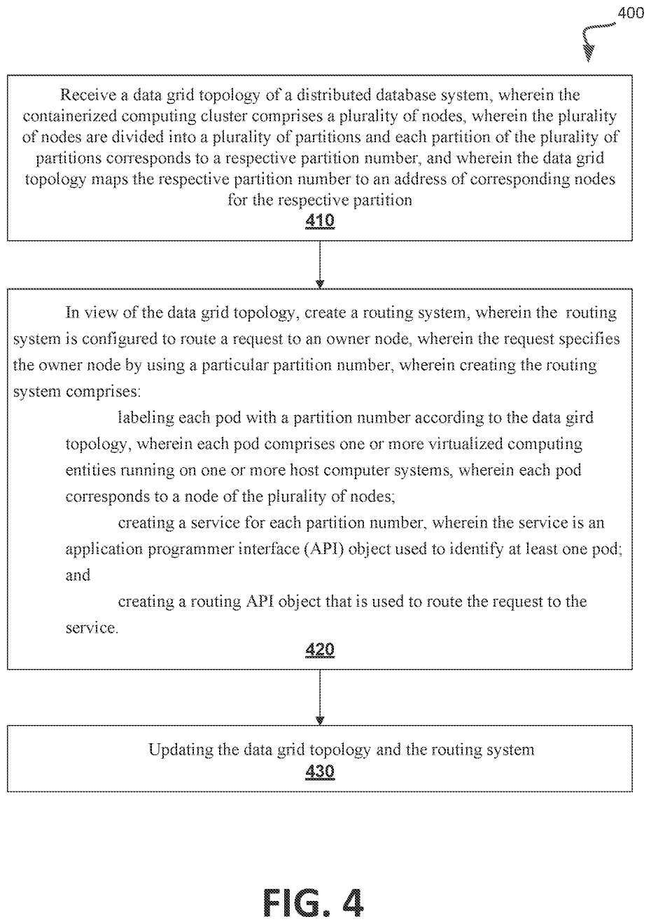

In some implementations, the server device 140 may include a topology and routing component 150, which can implement the routing methods described herein (e.g., methods 400-600 of FIGS. 4-6) for data grid in a containerized computing cluster. The details regarding topology and routing component 150 will be described with respect to FIGS. 2 and 3A-3D. Topology and routing component 150 may be an application that executes on server device 140. In some implementations, topology and routing component 150 can function as a web-based or cloud-based application that is accessible to the user via a web browser or thin-client user interface that executes on client device 160. For example, the client machine 160 may present a graphical user interface (GUI) 155 (e.g., a webpage rendered by a browser) to allow users to input data, which may be processed using topology and routing component 150. The process performed by topology and routing component 150 can be invoked in a number of ways, such as, e.g., a web front-end and/or a Graphical User Interface (GUI) tool. In some implementations, a portion of topology and routing component 150 may execute on client device 160 and another portion of network tool component 150 may execute on server device 140. While aspects of the present disclosure describe topology and routing component 150 as implemented in a PaaS environment, it should be noted that in other implementations, topology and routing component 150 can also be implemented in an Infrastructure-as-a-Service (IaaS) environment associated with a containerized computing services platform, such as Red Hat® OpenStack®. The functionality of topology and routing component 150 will now be described in further detail below with respect to FIGS. 2 and 3A-3D.

FIG. 2 illustrates an example system 200 that implements a topology and routing component 150. The system 200 includes a cluster 210. The cluster 210 is a cluster managed by a container orchestration system, such as Kubernetes®. Using clusters can allow a business entity having multiple services requirements to manage containerized workloads and services and facilitate declarative configuration and automation that is specific to one service among the multiple services.

The cluster 210 includes a control plane and a collection of nodes (e.g., nodes 111, 112, 121, 122) including a server node 230. The control plane is a collection of components that can make global control and management decisions about a cluster. The control plane is responsible for maintaining the desired state (i.e., a state desired by a client when running the cluster) of the cluster 210, and such maintaining requires information regarding which applications are running, which container images applications use, which resources should be made available for applications, and other configuration details. The control plane can be used to define the desired state of the cluster 210. For example, the desired state can be defined by configuration files including manifests, which are JSON or YAML files that declare the type of application to run and the number of replicas required to run. The control plane can provide an API, for example, using JSON over HTTP, which provides both the internal and external interface. The control plane can process and validate requests and update the state of the API objects in a persistent store, thereby allowing clients to configure workloads and containers across worker nodes. The control plane can monitor the cluster 210, roll out critical configuration changes, or restore any divergences of the state of the cluster 210 back to what the deployer declared.

The control plane can manage a set of controllers, such that each controller implements a corresponding control loop that drives the actual cluster state toward the desired state, and communicates with the API server to create, update, and delete the resources it manages (e.g., pods or service endpoints). For example, where the desired state requires two memory resources per application, if the actual state has one memory resource allocated to one application, another memory resource will be allocated to that application. The control plane can select a node for running an unscheduled pod (a basic entity that includes one or more containers/virtual machines and is managed by the scheduler), based on resource availability. The control plane can track resource use on each node to ensure that workload is not scheduled in excess of available resources. The control plane can include a persistent distributed key-value data store that stores the configuration data of the cluster, representing the overall state of the cluster at any given point of time.

The cluster 210 may provide a data grid deployed over a plurality of nodes including nodes 111, 112, 121, 122. The server node 230 can include a topology and routing component 150 that can implement a routing system for data grid in the cluster 210. In some implementations, the data grid (i.e., data distributed across the cluster 210) may use an application (“data grid application”) to manage the related data, for example, data grid topology of the cluster 210 to support the implementation of the routing system. In some implementations, the topology and routing component 150 includes a topology component 250 that obtains data grid topology of the cluster 210, an update component 240 that updates the data grid topology, a routing system component 260 that configures a routing system based on the data grid topology, a routing determination component 270 that determines a route for a request using the route system provided by the routing system component 260, and a request and route component 280 that receives a request of accessing an entry stored in a node and routes the request to the correct node. Each component will be described in detail below.

The topology component 250 can receive data grid topology data (e.g., a definition or description of the data grid topology) of the cluster 210. The data grid topology data includes a set of records, each record mapping of a partition of the nodes identified by a partition number to the network addresses of the nodes of the partition. In some implementations, the nodes of the cluster 210 can be partitioned into multiple partitions of the nodes, and each partition corresponds to a partition number. In some implementations, the topology component 250 can receive data grid topology data from a data grid API. In some implementations, the topology component 250 can receive data grid topology from an application (e.g., data grid application).

The update component 240 can update the data grid topology data of the cluster 210 by receiving the data grid topology data consistently. In some examples, the update component 240 may receive the updated (i.e., current) data grid topology data at a certain time periodically (e.g., at a predetermined frequency). In some examples, the update component 240 may receive the updated (i.e., current) data grid topology data upon detecting a trigger event, including that a node is instantiated, removed, or has failed. In some examples, the update component 240 may receive the updated (i.e., current) data grid topology data upon receiving a message regarding a change in the data grid topology data.

The routing system component 260 can enable the cluster 210 to configure and create a routing system based on the data grid topology data as described below. The routing system can be configured to route a request for accessing a node (e.g., node 111, 112, 121, 122) to the correct node. The request for accessing node may come from a client device to access data stored in a node or write data in a node, and the routing system component 260 can provide the routing system to be used to determine a route for the request.

In some implementations, to create the routing system, container orchestration systems or services, such as Red Hat® OpenShift®, Kubernetes®, can be used. Container orchestration systems, such as Kubernetes®, can manage containerized workloads and service and can facilitate declarative configuration and automation. Container orchestration systems can have built-in features to manage and scale stateless applications, such as web applications, mobile backends, and application programming interface (API) services, without requiring any additional knowledge about how these applications operate. For stateful applications, like databases and monitoring systems, which may require additional domain-specific knowledge, container orchestration systems can use operators, such as Kubernetes® Operator, to scale, upgrade, and reconfigure stateful applications. An operator refers to an application for packaging, deploying, and managing another application within a containerized computing services platform associated with a container orchestration system. A containerized computing services platform, such as Red Hat® OpenShift®, refers to an enterprise-ready container platform with full-stack automated operations that can be used to manage, e.g., hybrid cloud and multicloud deployments. A containerized computing services platform uses operators to autonomously run the entire platform while exposing configuration natively through objects, allowing for quick installation and frequent, robust updates. More specifically, applications can be managed using an application programming interface (API), and operators can be viewed as custom controllers (e.g., application-specific controllers) that extend the functionality of the API to generate, configure, and manage applications and their components within the containerized computing services platform. The container orchestration systems can use objects to represent the state of the cluster, where the objects are persistent entities (e.g., an endpoint stored in a persistent storage) in the API database of the cluster, including Pod, Service, Ingress, etc., as described below. #The container orchestration systems can run the workload by placing containers into Pods to run on nodes (e.g., node 111, 112, 121, 122). Each node is managed by the control plane and contains the services necessary to run Pods.

By using the container orchestration systems/services, the routing system component 260 can configure the routing system by labeling each Pod with a corresponding partition number according to the data grid topology, creating a Service associated with each partition number, and creating an Ingress that routes a request to the Service. Each step will be illustrated below in detail.

“Pod” refers to a group of one or more containers, with shared storage and network resources, and a specification for running the containers. The container orchestration system can give Pods their own IP addresses and can load-balance across the Pod. The containers in a Pod are automatically co-located and co-scheduled on the same physical or virtual machine in the cluster. The containers can share resources and dependencies, communicate with one another, and coordinate when and how they are terminated. Labels are key/value pairs that are attached to Pods and can be attached to objects at creation time and subsequently added and modified at any time. FIG. 3A shows the configuration file for a Pod named pod-a that has two labels datagridPartition: 1 and app:datagrid, a Pod named pod-b that has two labels datagridPartition:2 and app:datagrid, and a Pod named pod-c that has two labels datagridPartition:2 and app:datagrid. Here, datagridPartition: 1 and datagridPartition:2 each is a partition number used to identify a partition of nodes and can be calculated by a client device and included in a request sent by the client device, the detail of calculating of partition number will be described later. app:datagrid refers to the data grid application. The data grid topology used in FIG. 3A maps the partition number (“Partition1”) to the address of nodes (“datagrid-pod-a”) and maps the partition number (“Partition2”) to the address of nodes (“datagrid-pod-b”, “datagrid-pod-c”). As such, the routing system component 260 can label each Pod with a corresponding partition number according to the data grid topology.

“Service” refers to an abstract way to expose an application running on a set of Pods as a network service and define a logical set of Pods and a policy by which to access the set of Pods. The set of Pods targeted by a Service is usually determined by a selector, and the selector enables a controller continuously scans for Pods that match the label. For example, as shown in FIG. 3B, suppose a set of Pods each listens on a TCP port and contains a label “datagridPartition: 1 and app:datagrid,” this specification creates a new Service object named “datagridPartition1”, which targets TCP port on any Pod with the “datagridPartition: 1 and app:datagrid” label. The controller for the Service selector continuously scans for Pods that match its label, and then posts any updates to the object named “datagridPartition1”. Also as shown in FIG. 3B, suppose a set of Pods each listens on a TCP port and contains a label “datagridPartition:2 and app:datagrid,” this specification creates a new Service object named “datagridPartition2,” which targets TCP port on any Pod with the “datagridPartition:2 and app:datagrid” label. The controller for the Service selector continuously scans for Pods that match its label, and then posts any updates to the object named “datagridPartition2”. As such, the routing system component 260 can create a Service that is used to identify one or more Pods.

“Ingress” refers to an API object that manages external access to the Services in a cluster. Ingress exposes HTTP and HTTPS routes from outside the cluster to Services within the cluster. Traffic routing is controlled by rules defined on the Ingress resource. An Ingress may be configured to give Services externally-reachable uniform resource locators (URLs), etc. An Ingress needs a spec field, which has all the information needed to configure a load balancer or proxy server and contains a list of rules matched against all incoming requests. Ingress resource only supports rules for directing HTTP(S) traffic. As shown in FIG. 3C, Ingress rules apply to all inbound HTTP traffic, and path 1 has an associated backend defined with a Service named “datagridPartition1” and path 2 has an associated backend defined with a Service named “datagridPartition2.” When the content of an incoming request matches the path, the system directs traffic to the referenced Service. As such, the routing system component 260 can create an Ingress that is used to route a request to a Service. Therefore, the routing system created by the routing system component 260 will direct an incoming request with a partition number to the Service and then the Service is used to identify Pod labeled with the partition number, and thus identify the node running the Pod.

The request and route component 280 may receive a request from a client device. The request may be a request for accessing (e.g., reading, writing, erasing) data. The request may include a partition number that is calculated using the consistent hashing algorithm. For example, an entry's key is input in a client device and the client device may use the consistent hash function to calculate a hash value (HV) in a range of hash values that can be computed (e.g., integers ranging from 0-MAX_HASH_VALUE). The range of the hash values may be partitioned into a number of segments (SEGMENTS_NUM), and the segments may be mapped to the partitions of nodes according to the total available nodes of the cluster, where the total available nodes of the cluster is partitioned into a number of partitions and each partition of nodes corresponds to a partition number. As such, the hash value calculated using the consistent hash function can be used to calculate the appropriate segment S (e.g., S=round(HV*SEGMENTS_NUM/MAX_HASH_VALUE)), and the appropriate segment S can be used to find the corresponding partition number.

The client device may send the request including the partition number to the request and route component 280. In some implementation, the client device adds the partition number (e.g., OPx—owner partition number x) into a URI as a request (e.g., GET http://host.org/mycache/OPx/key=K). In some implementations, the request may include the key (e.g., key=K), the requested operation (e.g., reading, writing, erasing), a value (for a writing operation), and/or a lifespan or max-idle-time (if the particular data grid implements data expiration). The request and route component 280 may receive the request and send the request to the routing determination component 270.

After receiving the request, the routing determination component 270 can use the routing system configured by the routing system component 260 to determine a route for the request. The routing determination component 270 can use the partition number included in the request and find a route that directs the request to the Pod labelled with the partition number and the corresponding node. The routing determination component 270 can then send, to the request and route component 280, the information identifying the route or the node for servicing the request. FIG. 3D illustrates an example of routing requests to nodes in a cluster. A client device 160 sends one or more requests 340 to the cluster 310. The cluster 310, via the topology & routing component 150, routes the request to Services. For example, Ingress 350 has rules that route the requests (e.g., http://host.org/mycache/OP1; http://host.org/mycache/OP1) to the corresponding Services (e.g., Service named “datagridPartition1”; Service named “datagridPartition1”). The Service object 362 named “datagridPartition1” can select the Pods labelled with “datagridPartition: 1 and app:datagrid.” The Service object 364 named “datagridPartition1” can select the Pods labelled with “datagridPartition:2 and app:datagrid.” Pod 311 is selected corresponding to request http://host.org/mycache/OP1, and Pod 312 and Pod 313 are selected corresponding to request http://host.org/mycache/OP2. The Service object 364 can have further rules to choose between Pod 312 and Pod 313. Since Pod 311 runs on node 301, Pod 312 runs on node 302, Pod 313 runs on node 303, the node corresponding to the request is thus identified. In the example shown in FIG. 3D, data grid topology data includes mapping node 301 (e.g., via the address) to the partition 372 corresponding to the partition number 1 and mapping nodes 302 and 303 (e.g., via the address) to the partition 374 corresponding to partition number 2.

The request and route component 280, upon receiving the route and node identifying information, can direct the request to the identified node (i.e., owner node). The owner node may process the request received from the request and send a response to the client device. In some implementations, the key included in the request may be used to retrieve data from the owner node, and the owner node may send the retrieved data to the client device. Accordingly, from the perspective of client device, it may appear as though the data is retrieved directly from the owner node, and the server node 230 serves as a routing proxy hub with dynamic updating of the data grid topology.

FIGS. 4, 5, and 6 depict flow diagrams of illustrative examples of methods 400, 500, and 600 for implementing a routing system for data grid in a containerized computing cluster, in accordance with one or more aspects of the present disclosure. Methods 400, 500, and 600 and each of its individual functions, routines, subroutines, or operations may be performed by one or more processors of the computer device executing the method. In certain implementations, methods 400, 500, and 600 may be performed by a single processing thread. Alternatively, methods 400, 500, and 600 may be performed by two or more processing threads, each thread executing one or more individual functions, routines, subroutines, or operations of the method. In an illustrative example, the processing threads implementing methods 400, 500, and 600 may be synchronized (e.g., using semaphores, critical sections, and/or other thread synchronization mechanisms). Alternatively, the processes implementing methods 400, 500, and 600 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 4, method 400 may be performed by processing devices of a server of a cluster. At operation 410, the processing device receives a data grid topology of a containerized computing cluster, where the containerized computing cluster comprises a plurality of nodes, where the plurality of nodes are divided into a plurality of partitions and each partition of the plurality of partitions is identified a respective partition number, and the data grid topology maps the respective partition number to an address of corresponding nodes for the respective partition.

At operation 420, the processing device, in view of the data grid topology, creates a routing system that routes a request to an owner node, wherein creating the routing system comprises: labeling each pod with a corresponding partition number according to the data gird topology, where each pod comprises one or more virtualized computing entities running on one or more host computer systems, and each pod corresponds to a node of the plurality of nodes; creating a service for each partition number (i.e., a routing service that comprises an application programmer interface (API) object identifying at least one pod); and creating an ingress (i.e., a routing API object) that routes the request to the service. In some implementations, the routing system is managed using a container orchestration service, and wherein the pod, the service, and the ingress each corresponds to an endpoint managed by the container orchestration service. In some implementations, the pod comprises one or more virtualized computing entities running on one or more host computer systems and corresponds to a node, and wherein the service is used to identify at least one pod.

At operation 430, the processing device updates the data grid topology and the routing system. In some implementations, the processing device updates the data grid topology at a predetermined time and maintains the routing system corresponding to the updated data grid topology. In some implementations, the processing device updates the data grid topology upon detecting a trigger event and maintains the routing system corresponding to the updated data grid topology.

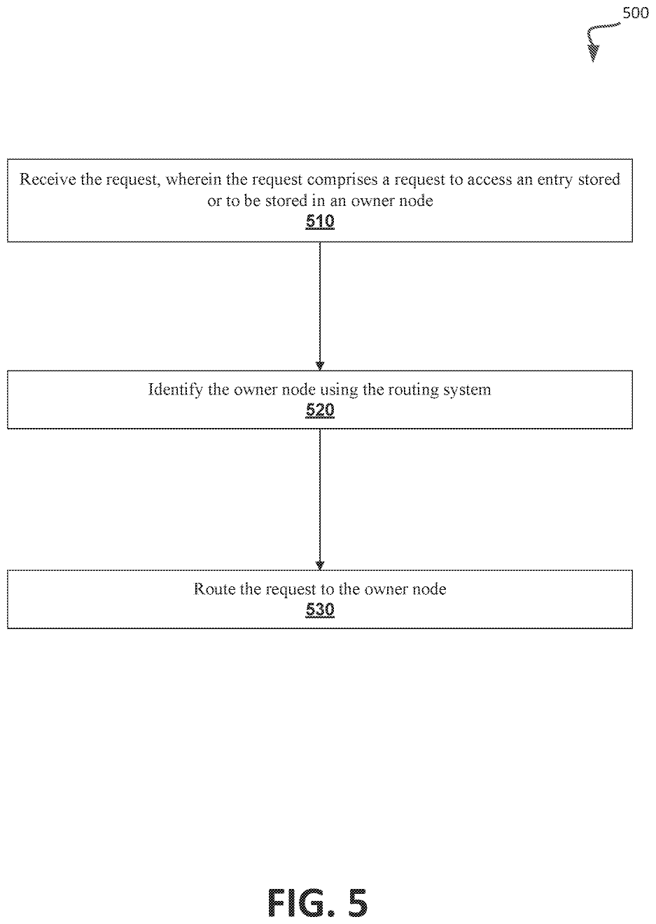

Referring to FIG. 5, method 500 may be performed by processing devices of a server of a cluster. At operation 510, the processing device receives the request, wherein the request comprises a request to access an entry stored in the owner node or to write an entry in the owner node. In some implementations, the request comprises a partition number computed by a consistent hash function based on a key of the entry. For example, an entry's key is input in a client device and the client device may use the consistent hash function to calculate a hash value (HV) in a range of hash values that can be computed (e.g., integers ranging from 0-MAX_HASH_VALUE). The range of the hash values may be partitioned into a number of segments (SEGMENTS_NUM), and the segments may be mapped to the partitions of nodes according to the total available nodes of the cluster, where the total available nodes of the cluster is partitioned into a number of partitions and each partition of nodes corresponds to a partition number. As such, the hash value calculated using the consistent hash function can be used to calculate the appropriate segment S (e.g., S=round(HV*SEGMENTS_NUM/MAX_HASH_VALUE)), and the appropriate segment S can be used to find the corresponding partition number.

In some implementations, the request is received from a client device. In some implementations, the request comprises a uniform resource locator (URL). In some implementation, the client device adds the partition number (e.g., OPx—owner partition number x) into a URI as a request (e.g., GET http://host.org/mycache/OPx/key=K). In some implementations, the request may include the key (e.g., key=K), the requested operation (e.g., reading, writing, erasing), a value (for a writing operation), and/or a lifespan or max-idle-time (if the particular data grid implements data expiration).

At operation 520, the processing logic determines the owner node using the routing system. After receiving the request, the processing logic can use the routing system to identify a route for the request. Specifically, the routing system is created by labeling each pod with a partition number according to the data gird topology, where each pod comprises one or more virtualized computing entities running on one or more host computer systems, where each pod corresponds to a node of the plurality of nodes; creating a service for each partition number, where the service is an application programmer interface (API) object used to identify at least one pod; and creating a routing API object that is used to route the request to the service. The processing logic can use the partition number included in the request and find a route that directs the request to the Pod labelled with the partition number and the corresponding node. In some implementations, the Ingress has rules that route the request to the corresponding Service, and the Service selects the Pod labeled as it scans for, thus, identifying a node that runs the Pod corresponding to the request.

At operation 530, the processing logic routes the request to the owner node. The processing logic can service the request according to the information identifying the route or the node. The processing logic can send the request to the owner node. The owner node may process the request received from the request and send a response to the client device. In some implementations, the key included in the request may be used to retrieve data from the owner node, and the owner node may send the retrieved data to the client device.

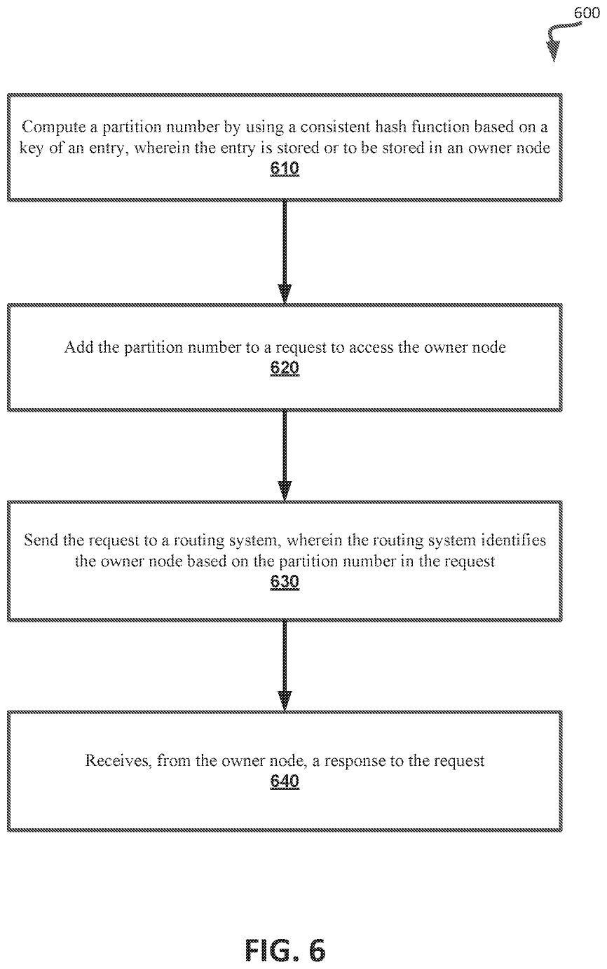

Referring to FIG. 6, method 600 may be performed by processing devices of a client of a cluster. At operation 610, the processing logic computes a partition number by using a consistent hash function based on a key of an entry, wherein the entry is stored or to be stored in an owner node. In some implementations, an entry's key is input in a processing logic and the processing logic may use the consistent hash function to calculate a hash value (HV) in a range of hash values that can be computed (e.g., integers ranging from 0-MAX_HASH_VALUE). The range of the hash values may be partitioned into a number of segments (SEGMENTS_NUM), and the segments may be mapped to the partitions of nodes according to the total available nodes of the cluster, where the total available nodes of the cluster is partitioned into a number of partitions and each partition of nodes corresponds to a partition number. As such, the hash value calculated using the consistent hash function can be used to calculate the appropriate segment S (e.g., S=round(HV*SEGMENTS_NUM/MAX_HASH_VALUE)), and the appropriate segment S can be used to find the corresponding partition number.

At operation 620, the processing logic adds the partition number to a request to access the owner node. In some implementation, the client device adds the partition number (e.g., OPx—owner partition number x) into a URI as a request (e.g., GET http://host.org/mycache/OPx/key=K). In some implementations, the request may include the key (e.g., key=K), the requested operation (e.g., reading, writing, erasing), a value (for a writing operation), and/or a lifespan or max-idle-time (if the particular data grid implements data expiration).

At operation 630, the processing logic sends the request to a routing system, wherein the routing system determines the owner node based on the partition number in the request, wherein the routing system is configured in view of data grid topology of a containerized computing cluster, and the containerized computing cluster comprises a plurality of nodes, wherein the plurality of nodes are divided into a plurality of partitions and each partition of the plurality of partitions corresponds to a respective partition number, and wherein the data grid topology maps the respective partition number to a corresponding addresses of each partition of the plurality of partitions of the plurality of nodes. The data grid topology is received and maintained by the routing system.

At operation 640, the processing logic receives, from the owner node, a response to the request. In some implementations, the key included in the request may be used to retrieve data from the owner node, and the owner node may send the retrieved data to the client device. In some implementations, the owner node may write the data included in the request.

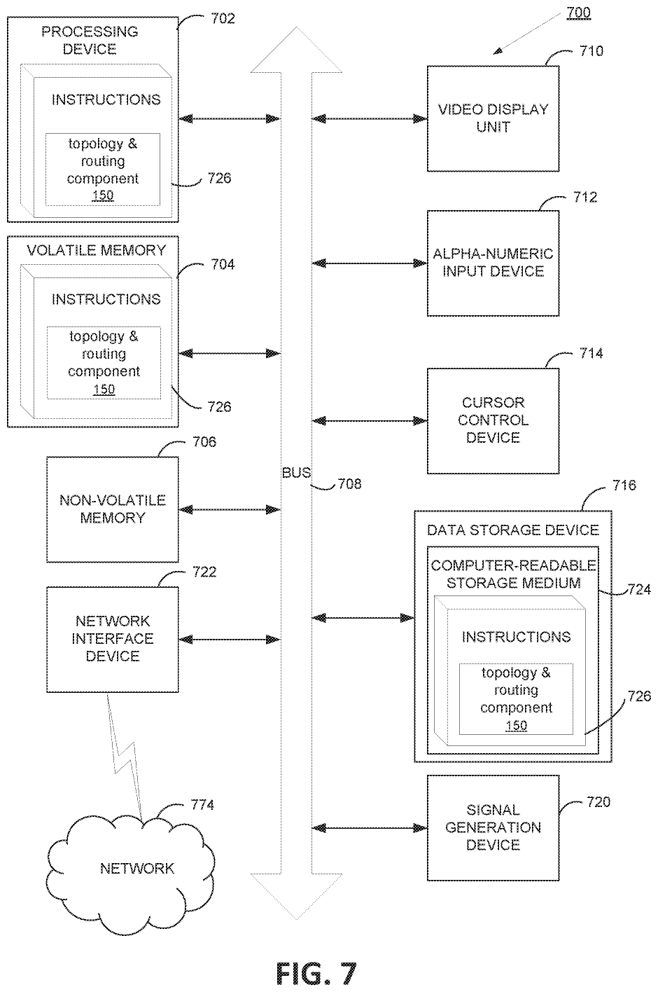

FIG. 7 depicts an example computer system 700, which can perform any one or more of the methods described herein. In one example, computer system 700 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 716, which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application-specific integrated circuit (ASIC), a field-programmable gate array (FPGA), a digital signal processor (DSP), network processor, or the like. The processing device 702 is configured to execute processing logic (e.g., instructions 726) that includes the topology and routing component 150 for performing the operations and steps discussed herein (e.g., corresponding to the method of FIGS. 4-6, etc.).

The computer system 700 may further include a network interface device 722. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker). In one illustrative example, the video display unit 710, the alphanumeric input device 712, and the cursor control device 714 may be combined into a single component or device (e.g., an LCD touch screen).

The data storage device 716 may include a non-transitory computer-readable medium 724 on which may store instructions 726 that include topology and routing component 150 (e.g., corresponding to the methods of FIGS. 4-6) embodying any one or more of the methodologies or functions described herein. Network tool component 150 may also reside, completely or at least partially, within the main memory 704 and/or within the processing device 702 during execution thereof by the computer system 700, the main memory 704, and the processing device 702 also constituting computer-readable media. Topology and routing 150 may further be transmitted or received via the network interface device 722.

While the computer-readable storage medium 724 is shown in the illustrative examples to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Other computer system designs and configurations may also be suitable to implement the systems and methods described herein.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative and not restrictive. Many other implementations will be apparent to those of skill in the art upon reading and understanding the above description. Therefore, the scope of the disclosure should be determined with reference to the appended claims, along with the full scope of equivalents to which such claims are entitled.

In the above description, numerous details are set forth. However, it will be apparent to one skilled in the art that aspects of the present disclosure may be practiced without these specific details. In some instances, well-known structures and devices are shown in block diagram form rather than in detail in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for specific purposes, or it may include a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Aspects of the disclosure presented herein are not inherently related to any particular computer or other apparatus. Various general-purpose systems may be used with programs in accordance with the teachings herein, or it may prove convenient to construct a more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, the use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A method comprising:
receiving, by a processing device, a description of a data grid topology of a containerized computing cluster, wherein the containerized computing cluster comprises a plurality of nodes, wherein the plurality of nodes are divided into a plurality of partitions and each partition of the plurality of partitions is identified by a respective partition number, and wherein the data grid topology maps the respective partition number to an address of corresponding nodes for the respective partition;
labeling each pod with a partition number according to the data gird topology, wherein each pod comprises one or more virtualized computing entities running on one or more host computer systems, wherein each pod corresponds to a node of the plurality of nodes;
creating a routing service for each partition number, wherein the routing service comprises an application programmer interface (API) object identifying at least one pod; and
creating a routing API object to route a request to the routing service.

2. The method of claim 1, further comprising:
updating the data grid topology at a predetermined time; and
updating the labeling of each pod corresponding to the updated data grid topology.

3. The method of claim 1, further comprising:
updating the data grid topology upon detecting a trigger event; and
updating the labeling of each pod corresponding to the updated data grid topology.

4. The method of claim 1, further comprising:
receiving the request, wherein the request specifies to access an entry stored in an owner node or write the entry in the owner node;
identifying the owner node using the labelled pod, the routing service, and the routing API object; and
routing the request to the owner node.

5. The method of claim 4, wherein the request includes a partition number computed by a consistent hash function based on a key of the entry.

6. The method of claim 4, wherein the request is received from a client device, and wherein a respond from the owner node is sent to the client device.

7. The method of claim 1, wherein the request comprises a uniform resource locator (URL).

8. The method of claim 1, wherein the routing service and the routing API object each corresponds to an endpoint managed by a container orchestration service.

9. The method of claim 1, wherein the data grid topology maps the respective partition number to a pod of corresponding nodes for the respective partition.

10. A system comprising:
a memory;
a processing device coupled to the memory, the processing device to perform operations comprising:
computing a partition number by using a consistent hash function based on a key of an entry, wherein the entry is stored or to be stored in an owner node;
adding the partition number to a request to access the owner node;
sending the request to a routing system, wherein the routing system identifies the owner node based on the partition number in the request, wherein the routing system is created in view of a data grid topology of a containerized computing cluster, wherein the containerized computing cluster comprises a plurality of nodes, wherein the plurality of nodes are divided into a plurality of partitions and each partition of the plurality of partitions is identified by a respective partition number, and wherein the data grid topology maps the respective partition number to an address of corresponding nodes for the respective partition; and
receiving, from the owner node, a response to the request.

11. The system of claim 10, wherein the request comprises a uniform resource locator (URL).

12. The system of claim 10, wherein the data grid topology is received and maintained by the routing system.

13. A non-transitory computer-readable storage medium comprising instructions that, when executed by a processing device, cause the processing device to perform operations comprising:
receiving a description of a data grid topology of a containerized computing cluster, wherein the containerized computing cluster comprises a plurality of nodes, wherein the plurality of nodes are divided into a plurality of partitions and each partition of the plurality of partitions is identified by a respective partition number, and wherein the data grid topology maps the respective partition number to an address of corresponding nodes for the respective partition; and
in view of the data grid topology, creating a routing system, wherein the routing system is configured to route a request to an owner node, wherein the request specifies the owner node by using a particular partition number, wherein creating the routing system comprises:
labeling each pod with a partition number according to the data gird topology, wherein each pod comprises one or more virtualized computing entities running on one or more host computer systems, wherein each pod corresponds to a node of the plurality of nodes;
creating a service for each partition number, wherein the service comprises an application programmer interface (API) object identifying at least one pod; and
creating a routing API object to route the request to the service.

14. The non-transitory computer-readable storage medium of claim 13, wherein the processing device is to further perform operations comprising:
updating the data grid topology at a predetermined time; and
updating the routing system corresponding to the updated data grid topology.

15. The non-transitory computer-readable storage medium of claim 13, wherein the processing device is to further perform operations comprising:
updating the data grid topology upon detecting a trigger event; and
updating the routing system corresponding to the updated data grid topology.

16. The non-transitory computer-readable storage medium of claim 13, wherein the processing device is to further perform operations comprising:
receiving the request, wherein the request specifies to access an entry stored in the owner node or write the entry in the owner node;
identifying the owner node using the routing system; and
routing the request to the owner node.

17. The non-transitory computer-readable storage medium of claim 16, wherein the request includes a partition number computed by a consistent hash function based on a key of the entry.

18. The non-transitory computer-readable storage medium of claim 13, wherein the request comprises a uniform resource locator (URL).

19. The non-transitory computer-readable storage medium of claim 13, the routing system is managed using a container orchestration service, and wherein the pod, the service, and the routing API object each corresponds to an endpoint managed by the container orchestration service.

20. The non-transitory computer-readable storage medium of claim 19, wherein the data grid topology maps the respective partition number to a pod of corresponding nodes for the respective partition.
